(19) United States
(12) Patent Application Publication
(10) Pub. No.: US 2009/0009609 A1
(43) Pub. Date: Jan. 8, 2009

(54) PHOTOGRAPHING DEVICE WITH IMAGE OUTPUT CONTROL FUNCTION

(75) Inventor: Hirokazu MAEDA, Tokyo (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/167,404

(22) Filed: Jul. 3, 2008

(30) Foreign Application Priority Data
Jul. 5, 2007 (JP) 2007-177750

(51) Int. Cl. H04N 5/225

(52) U.S. Cl. 348/207.1

(57) ABSTRACT

A photographing device outputs image data signals to a peripheral device that reproduces the image data signals in a reproduction format predetermined according to the location where the peripheral device is actually used. The photographing device includes an output-format selector and an information receiver. The output-format selector selects an output format for the image data signals to be output to the peripheral device. The information receiver receives location information for where the peripheral device is in actual use. The output-format selector selects the output format corresponding to the reproduction format, based on reproduction-format information and the location information. The reproduction-format information represents the match between a plurality of the reproduction formats and the locations on the earth where each reproduction format is employed.

### BACKGROUND OF THE INVENTION

1. Field of the Invention

The present invention relates to a photographing device with an image output function, and especially, to a photographing device which can control subject image output to an image reproduction device.

2. Description of the Related Art

A photographing device such as a digital camera or a video camera can display a generated image on a monitor provided thereon. Furthermore, when such a photographing device is connected to an image reproduction device such as a television, it can also output image data to the television so that an image is reproduced by the image reproduction device.

Image reproduction formats employed in televisions are mainly divided into the NTSC system and PAL system. In Japan, the United States, and other countries, the NTSC system is employed, and in Europe, China and other areas, the PAL system is employed.

When image data signals are output from a photographing device to a television and are reproduced by the television, it is necessary to select the output format (i.e. the video output format) for the image data according to whether the television employs the NTSC or PAL system, as well as other factors. Therefore, if the user is unaware of this requirement, suitable operations may not be carried out and the image may not be correctly reproduced. For example, in a location where the PAL system is employed in televisions as the image reproduction format, if an image is output from a photographing device to the television using the NTSC system, the image will be garbled.

### SUMMARY OF THE INVENTION

Therefore, an object of the present invention is to provide a photographing device which can reliably select a suitable output format for an image to be output to an external image reproduction device, according to the image reproduction format employed by the image reproduction device.

A photographing device according to the present invention, outputs image data signals to a peripheral device that reproduces the image data signals in a reproduction format according to the location where the peripheral device is actually used. The photographing device includes an output-format selector and an information receiver. The output-format selector selects tile output format for the image data signals to be output to the peripheral device. The information receiver receives location information for where the peripheral device is in actual use. The output-format selector selects the output format corresponding to the reproduction format, based on reproduction-format information and the location information. The reproduction-format information represents the match between a plurality of the reproduction formats and the locations on the earth where each reproduction format is employed.

### BRIEF DESCRIPTION OF THE DRAWINGS

The present invention will be better understood from the description of the preferred embodiments of the invention set forth below, together with the accompanying drawings, in which:

FIG. 1 is a block diagram of a digital camera of a first embodiment;

FIG. 2 shows an example of a menu screen displayed on an LCD monitor;

FIG. 3 is an approximate representation of a correspondence list between locations with given time zones and their television image reproduction formats;

FIG. 4 is a block diagram of a digital camera of a second embodiment;

FIG. 5 is an approximate representation of a correspondence list between locations on the earth and the identifiers used in reproduction-format data;

FIG. 6 is a flowchart representing an output-format setting routine used to select the output-format of an image; and

FIG. 7 is a flowchart representing an output-format changing routine used to change the output-format of an image.

### DESCRIPTION OF THE PREFERRED EMBODIMENTS

Hereinafter, the preferred embodiments of the present invention are described with reference to the attached drawings.

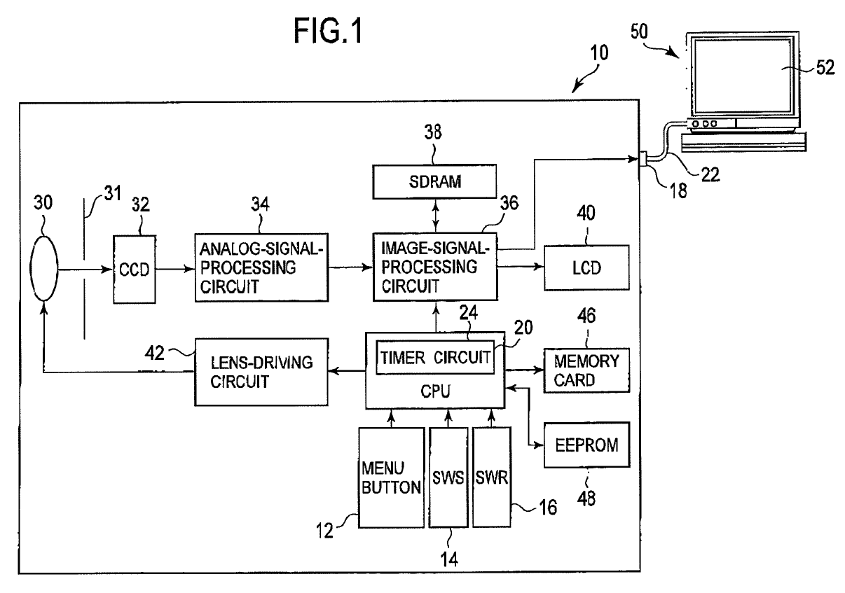

As shown in FIG. 1, in a digital camera 10 (a photographing device), a CPU 20 which controls the entire digital camera, n LCD monitor 40, and others are provided. A menu button 12, a photometry-measuring switch (SWS) 14, and a release switch (SWR) 16 are connected to the CPU 20, so that predetermined signals according to operations of the user are transmitted to the CPU 20. A television 50 (a peripheral device) can be connected to the CPU 20 via a connection terminal 18 and a cable 22.

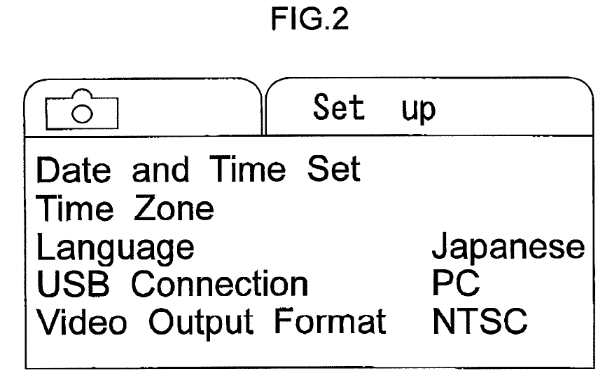

When the menu button 12 i s depressed, a menu screen (see FIG. 2) is displayed on the LCD monitor 40, under the control of the CPU 20. The user can select a various menu items on the menu screen, for photographing, reproducing an image and so on.

On the menu screen, menu items for selecting the output format for an image to be output to the television 50, corresponding to the video output method (the image reproduction format), that is, the NTSC system or PAL system employed by the television 50, are displayed. For example, in the menu screen of FIG. 2, by selecting between menu items “NTSC” or “PAL” through operations of the menu button 12 (see FIG. 1) and other buttons, and then by depressing the OK button (not shown), the output format for an image, corresponding to the image reproduction format (e.g., the NTSC or PAL system) of the television 50, can be selected.

When the menu screen is displayed on the LCD monitor 40, the date and time set in the digital camera 10 can be changed. That is, when the user moves from the location to another anywhere in the world, the time for that location can be selected (hereinafter, called time zone). In this case, the user selects the menu item of “Time zone” as shown in FIG. 2, and then selects a location such as the name of a city on the display. As a result of this operation, the time zone according to that location is selected and set, under the control of the CPU 20 (see FIG. 1). The time at the set time zone can be displayed on a predetermined image on the LCD monitor 40 or on a generated subject image.

When a release button (not shown) is half depressed, the photometry-measuring switch 14 is turned on. When the photometry-measuring switch 14 is turned on in a photographing mode which is set by predetermined button operations, the distance to the subject in measured by a distance meter (not shown), and photometry of a subject is measured by a photometry meter (not shown). The obtained distance and photometry data are transmitted to the CPU 20. The CPU 20 controls a lens-driving circuit 42 to adjust the position of a photographing lens 30 for focusing, based on the distance data.

When the release button is fully depressed, a release switch 16 is turned on. Then, an aperture 31 is opened to a predetermined size by the aperture-driving circuit (not shown), and a shutter (not shown) is opened to the predetermined position for a predetermined time based on the control signals from the CPU 20. And then a COD 32 (an image generator) is exposed by the light reflected from the subject and transmitted through the photographing lens 30.

In the exposed CCD 32, image signals corresponding to the subject image are generated. The generated analog image signals are amplified in an analog-signal-processing circuit 34, and then converted to digital signals. The digital image signals are transmitted to an image-signal-processing circuit 36. In the image-signal-processing circuit 36, image signals are further processed. The processed image data are temporarily stored in an SDRAM 38, and then stored in a memory card 46.

Note that when the television 50 is connected to the digital camera 10, generated image data can be transmitted to the television 50 and a moving image can be displayed on a monitor 52. In this case, it is possible to switch the output formats of the image to be output to the television 50, for example, by stitching between the video output format corresponding to the NTSC system (hereinafter, called “NTSC format”) and that corresponding to the PAL system (hereinafter, called “PAL format”). Note that when the NTSC format is set, “NTSC” is displayed as shown in FIG. 2.

When setting of the NTSC format is commanded, the signals of the image data output to the television 50 are generated to follow the scanning lines of the NTSC system, and when setting of the PAL format is commanded, the signals of the image data output to the television 50 are generated to follow the scanning lines or the PAL system. That is, when the output format is switched by operations of the menu button 12 and so on, signals commanding output of the image data in the newly selected output format are transmitted from the CPU 20 to the image-signal-processing circuit 36. As a result, the image-signal-processing circuit 36 outputs the image to the television 50, in the commanded video output format.

In an EEPROM 48 (a memory), various data for signal processing by the CPU 20 are stored. For example, data necessary for selecting either the NTSC format or PAL format, and for switching between them, are stored in the EEPROM 48, as explained below.

A timer circuit 24 is provided in the CPU 20, to keep the real time at the standard location. As explained below, data representing time differences between the locations on the earth and the standard location is provided in the EEPROM 48, so that time zones around the earth, and not only that including Japan, can be set.

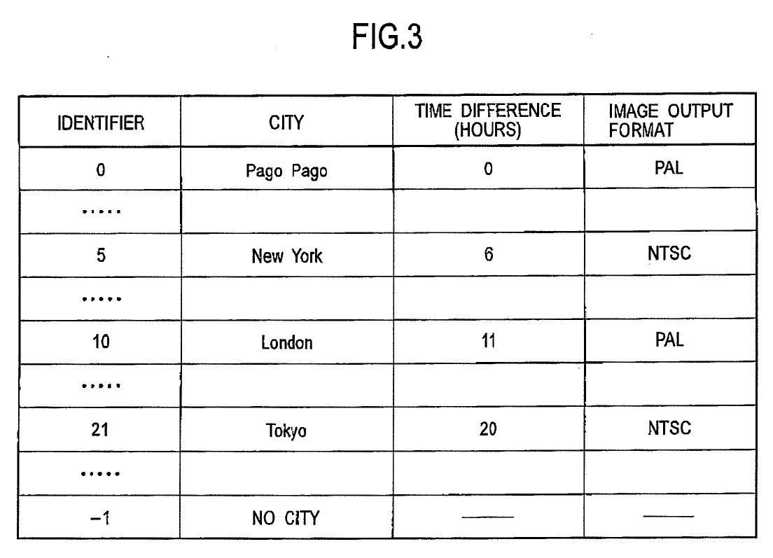

Reproduction-format data (reproduction-format information; see FIG. 3) representing the correspondence between different earth locations and the image reproduction formats employed in those locations, is stored in the EEPROM 48. The reproduction-format data includes time-difference information representing time differences between the locations at different time zones and a standard location. In this embodiment, the standard location is Pago Pago, and the time differences between Pago Pago and other locations such as New York, London, and Tokyo are included in the reproduction-format data. In the reproduction-format data, an identifier is allocated to each of the locations including the above cities, and the identifiers are used in the second embodiment explained below.

It is known that the NTSC and PAL systems are used as the image reproduction formats around the world. Therefore, reproduction-format data representing the match between the locations (cities) where the time zones are set, that is, the locations where the television 50 (see FIG. 1) could be used, and their image reproduction formats, can be prepared in advance.

When, for example, a user traveling from Japan to London, changes the time zone from Japan (Tokyo) to London, that is, indicates that the location where the television 50 is actually used should be switched to London, the CPU 20 receives the command signals. Then, the CPU 20 switches not only the time zone, but also the image reproduction format from the NTSC format to the PAL format, based on the reproduction-format data.

That is, the NTSC format which is previously set by default or user command before the time zone has been changed is automatically set to the PAL format, which is employed in and around London. This is because the time zone for London was selected, and it is determined by the CPU 20 that the current location of the digital camera 10 is in or around London, by which the television 50 and the user can also be expected to be in or around London.

Therefore, the video output format (the NTSC format or PAL format) corresponding to the image reproduction format of the television 50 can always be selected, oven when a user unaware of the necessity of switching the video output format or who forgets to switch it, outputs a subject image photographed by the digital camera 10 on overseas travel. As a result, the image is correctly displayed on the television 50, regardless of the location where the television 50 is used and where the user is. Note that, when the PAL format was set in advance by user command before the time zone was changed, the PAL format selection is maintained.

As explained above, in the first embodiment, when the user who has traveled abroad adjusts the time zone set in the digital camera 10 according to his or her location, the video output format corresponding to the image reproduction format for that location, that is, the location where the television 50 is actually used, is automatically selected and set. Travelers routinely adjusts the time zone set in the digital camera 10, so that images will always be correctly displayed on the television 50, regardless of the image reproduction format employed in the current location of the user.

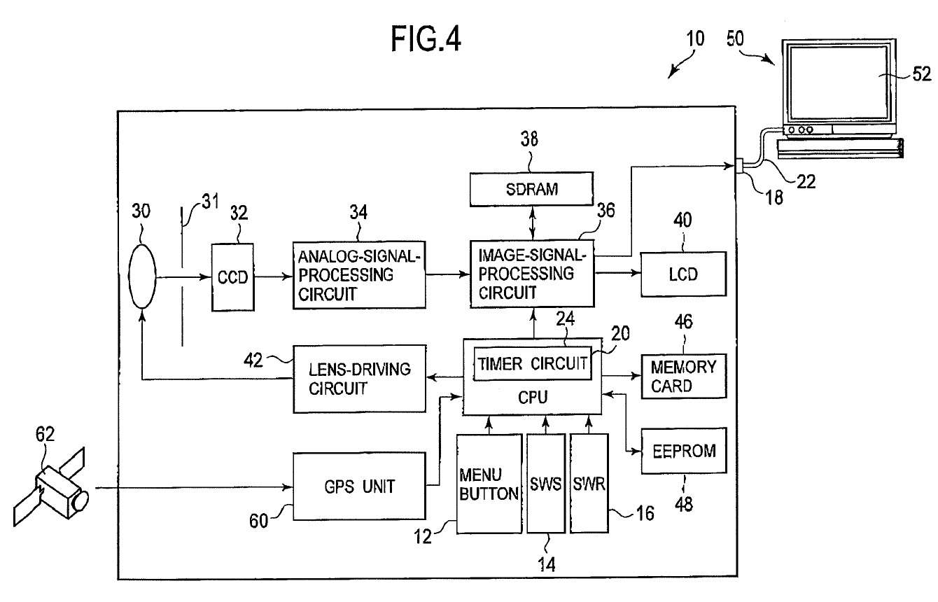

Next, the second embodiment is explained, with attention paid mainly to the differences between it and the first embodiment. As represented in FIG. 4, in this embodiment, a GPS unit 60 (an information-receiver) is provided. Note that in FIG. 4, the components corresponding to those of the first embodiment are identified by the same numerals. The GPS unit 60 received location information which represents the latitude and longitude of the digital camera 10 on the earth, from an artificial satellite 62 (an external information source). The received location information is transmitted from the GPS unit 60 to the CPU 20 via an interface (not shown).

Therefore, in this embodiment, the location of the digital camera 10 can be accurately specified. Accordingly, the location where the television 50 which is connected to the digital camera 10 is used can be more accurately specified than in the first embodiment in which the position of the television 50 is specified based on the time zone selected by the user. As is clear from the above explanation, the location information received by the GPS unit 60 is used as the information which represents the location where the television 50 is in actual use.

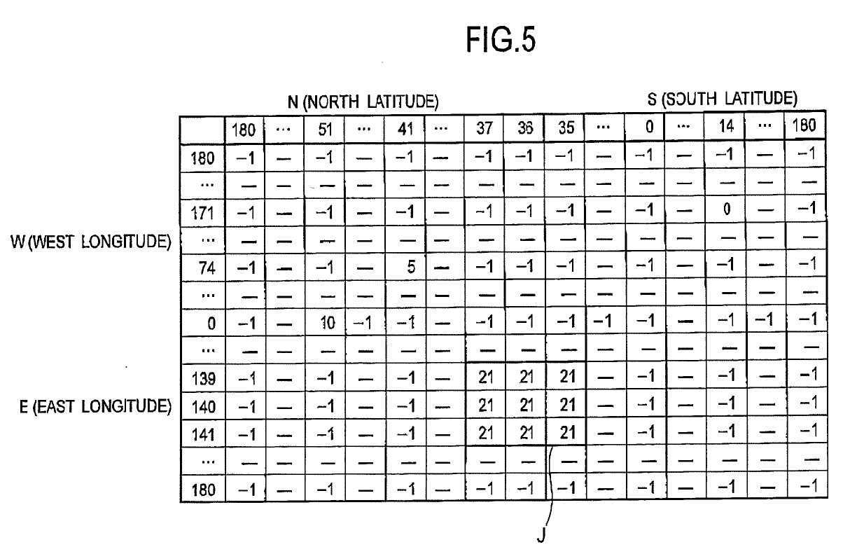

In this embodiment, area data as represented in FIG. 5 is used to utilize the location information representing the location of the television 50 in use as explained above. The area data represents the match between areas on the earth divided by latitudes and longitudes (hereinafter, called divisions), and the identifiers included in the reproduction-format data (see FIG. 3).

The CPU 20 which receives the location information transmitted from the GPS unit 60 reads the area data previously stored in the EEPROM 49. Then, the identifier which corresponds to the location information is read and the reproduction format employed in the city (area) corresponding to the distinguished identifier in the reproduction-format data (see FIG. 3) is specified by the CPU 20. As a result, the image output format corresponding to the location where the digital camera 10 is at the moment, that is, the location where the television 50 connected to the digital camera 10 is in actual use, is automatically selected and set.

Video standards (the image reproduction formats) are usually determined for countries, as a whole, or for areas encompassing multiple countries. Therefore, in the area data, the same identifier is assigned to a plurality of divisions. For example, regarding an area represented by Tokyo (see FIG. 3), that is, in the ease of Japan, the same identifier “21” is assigned to all the divisions between the north latitude 35° to 37° and east longitude 139° to 141°, designated zone “J” and demarcated by the bold line in FIG. 5.

Note that the identifier “−1” represents areas with no human inhabitants, such as ocean areas, and setting the time difference and image reproduction format is meaningless (see FIGS. 3 and 5). When the identifier read by the CPU 20 is changed to “−1”, the video output format is maintained. That is, when new location information is received and the identifier read by the CPU 20 is changed from anything but “−1” to “−1”, the video output format is not changed. Note that the area data represented in FIG. 5 is only an example, and the divisions may be more finely divided, for zones where different image reproduction formats are employed within a small area which may contain neighboring nations.

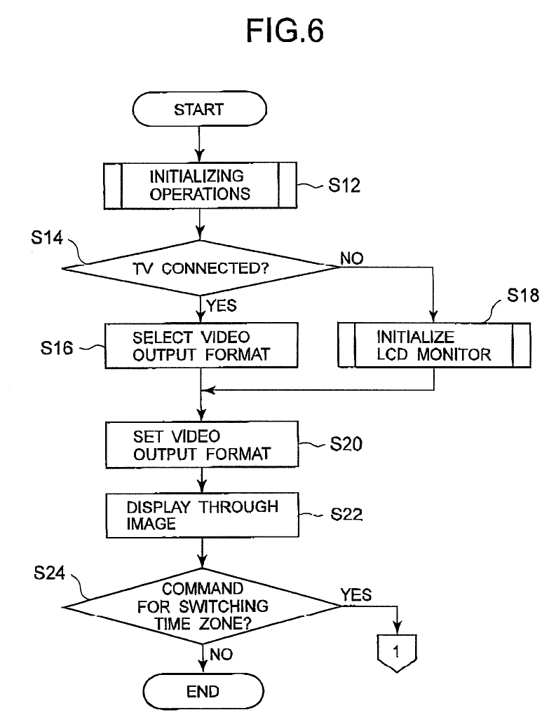

The output-format setting routine (see FIG. 6) starts when a main switch of the digital camera 10 is turned on. At step S12, initializing operations of the digital camera 10, such as the setting of parameters and displaying of the initial screen on the LCD monitor 40, are carried out, and the process proceeds to step S14. At stop S14, it is determined whether the digital camera 10 is connected to the television 50 or not. When it is determined that the digital camera 10 is connected to the television 50, the process proceeds to step S16. When it is determined that the digital camera 10 is not connected to the television 50, the process proceeds to step S18.

At step S16, operations for selecting the video output format, corresponding to the location where the television 50 is actually used are carried out based on the location information from the GPS unit 60 and the reproduction-format data (see FIG. 3). Then, the process proceeds to step S20. At step S20, either the NTSC format or PAL format is set, according to the result of the operation at step S16. Then, the process proceeds to step S22.

On the other hand, at step S18, operations for initializing the LCD monitor 40 (see FIG. 4) are carried out so that an image is displayed on the LCD monitor 40, without being displayed on the monitor 52 of the television 50. Then, the process proceeds to step S20. In this case, at step S20, the NTSC format is set by default.

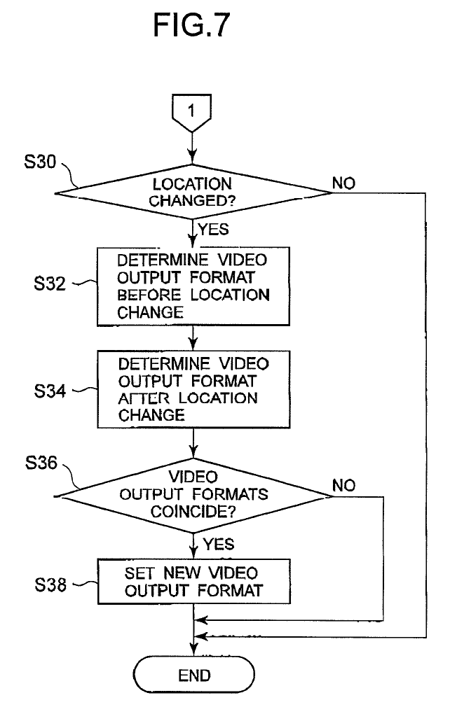

At step S22, a through image of a subject is displayed on the monitor 52 of the television 50 or the LCD monitor 40, and the process proceeds to step S24. At step S24, it is determined whether switching of the time zone has been commanded by the user. When it is determined that switching of the time zone has been commanded, the output-format changing routine (see FIG. 7) starts. Otherwise, it is determined switching the time zone is not commanded, the output-format setting routine ends.

When the output-format changing routine starts, at step S30 (see FIG. 7), it is determined whether the location of the digital camera 10 has been changed. If it is determined that the location of the digital camera 10 has been changed, the process proceeds to step S32. Otherwise, the output-format changing routine ends.

At step S32, the CPU 20 determines whether the video output format which had been set before the change of the location of the digital camera 10 is the NTSC format or PAL format. Then the process proceeds to step S34. At step S34, the CPU 20 determines whether the video output format is the NTSC format or PAL format, based on the latest location information generated after the change of the location of the digital camera 10. Then the process proceeds to step S36.

At step S36, it is determined whether the video output format set before the change of the location of the digital camera 10 and which was determined at step S32, coincides with the video output format which was set after the change of the location of the digital camera 10 and which was determined at step S34. If it is determined that the video output formats coincide, the process proceeds to stop S38. If it is determined that the video output formats do not coincide, the output-format changing routine ends. At step S38, the video output format corresponding to the image reproduction format used in the new location of the digital camera 10, that is, the new location of the television 50, is selected and set. Then, the output-format changing routine ends.

Note that, at step S16 in the output-format setting routine (see FIG. 6) of the first embodiment, operations for selecting the video output format are carried out, based on only the reproduction-format data (see FIG. 3), not on the location information from the GPS unit 60. In the output-format changing routine (see FIG. 7) of the first embodiment, step S30 is omitted.

As explained above, in the second embodiment, when a new world time is selected, the video output format is automatically selected, based on the information from the GPS 60 and the reproduction-format date. Therefore, the location where the television 50 is actually used is specified more accurately than in the first embodiment, and selecting or setting an unsuitable video output format due to wrong selection of the time zone by the user, is prevented. As explained above, in the digital camera 10 of the second embodiment, a suitable video output format can always be reliably selected.

In the second embodiment, the GPS unit 60 may be controlled to receive location information at predetermined time intervals. In this case, regardless of the user command for switching tho time zone (step S24 in FIG. 6), a suitable video output format can always be selected, although the operational load of the CPU 20 will increase.

In both embodiments, the subject of the present invention is not limited to the digital camera 10, and may include a video camera, or other photographing devices. The video output format is not limited to the NTSC format or PAL format, and other video output formats which do not correspond to the NTSC system or PAL system, may be selected or set. Furthermore, both the NTSC format and PAL format may be more finely classified, and some of these video output formats may be selected or set.

The invention is not limited to that described in the preferred embodiments; namely, various improvements and changes may be made to the present invention without departing from the spirit and scope thereof.

The present disclosure relates to subject matter contained in Japanese Patent Application No. 2007-177750 (filed on Jul. 5, 2007) which is expressly incorporated herein, by reference, in its entirety.

1. A photographing device that outputs image data signals to a peripheral device that reproduces said image data signals in a reproduction format predetermined according to the location where said peripheral device is actually used, said photographing device comprising:
an output-format selector that selects an output format for said image data signals to be output to said peripheral device; and
an information receiver that receives location information for where said peripheral device is in actual use, said output-format selector selecting said output format corresponding to said reproduction format, based on reproduction-format information and said location information, said reproduction-format information representing the match between a plurality of said reproduction formats and the locations on the earth where said reproduction format is employed.

2. The photographing device according to claim 1, wherein said location information is input by the user.

3. The photographing device according to claim 2, further comprising a time-zone selector that selects the time zone according to the location where said peripheral device is in actual use, from a list of the time zones corresponding to said locations on the earth, based on said location information.

4. The photographing device according to claim 1, further comprising a memory in which said reproduction-format information is stored.

5. The photographing device according to claim 4, wherein time-difference information that represents time differences between said locations on the earth and a standard location, is also stored in said memory.

6. The photographing device according to claim 1, wherein said information receiver receives said location information from an external information source.

7. The photographing device according to claim 1, further comprising a time-zone selector that selects the time zone according to the location where said peripheral device is in actual use, from a list of the time zones corresponding to said locations on the earth, by user command, and said output-format selector selects said output format when a new time zone is selected by said time-zone selector.

8. The photographing device according to claim 1, wherein said output-format selector maintains said output format when predetermined location information is received.

9. The photographing device according to claim 1, wherein said reproduction format is the NTSC system or PAL system.

10 The photographing device according to claim 1, further comprising an image generator that generates said image data signals.
